(19) United States
(12) Patent Application Publication
(10) Pub. No.: US 2026/0310449 A1
(43) Pub. Date: Oct. 8, 2026

(54) INTELLIGENT STALE BUG DETECTION AND PRIORITIZATION SYSTEM

(71) Applicant: Microsoft Technology Licensing, LLC, Redmond, WA (US)

(72) Inventor: Shubham AGARWAL, Bengaluru (IN)

(21) Appl. No.: 19/098,429

(22) Filed: Apr. 2, 2025

(51) Int. Cl. G06F 8/70

(52) U.S. Cl. CPC G06F 8/70

(57) ABSTRACT

Provided herein are systems, methods, machine-readable media, and the like, for bug mitigation in a software application. A method includes accessing bug data of a bug of the software application that is not resolved, performing temporal decay analysis (TDS) on the bug that assesses developer activity on and lifecycle of the bug over time to identify that the bug has become stale, responsive to identifying the bug has become stale, flagging the bug as stale, performing (i) evolutionary relevance mapping on the bug to determine the bug is still relevant in a current instance of the software application or (ii) cross-version similarity modeling to identify the bug has recurred in the current instance of the software application, and mitigating the bug responsive to determining the bug is still relevant or has recurred in the current instance of the software application resulting in an updated software application.

### TECHNICAL FIELD

Aspects of the application regard triaging bugs in software.

### BACKGROUND

Modern software development environments generate vast volumes of bug reports across multiple platforms, features, and user environments. Traditional bug triaging tools face several challenges in managing this scale and complexity. The accumulation of unresolved or inactive bug reports-commonly referred to as “stale bugs”-creates significant challenges in modern software development. These challenges include repository clutter, wasted resources, missed recurrence patterns, static and oversimplified identification, and manual effort and oversight.

### BRIEF DESCRIPTION OF DRA WINGS

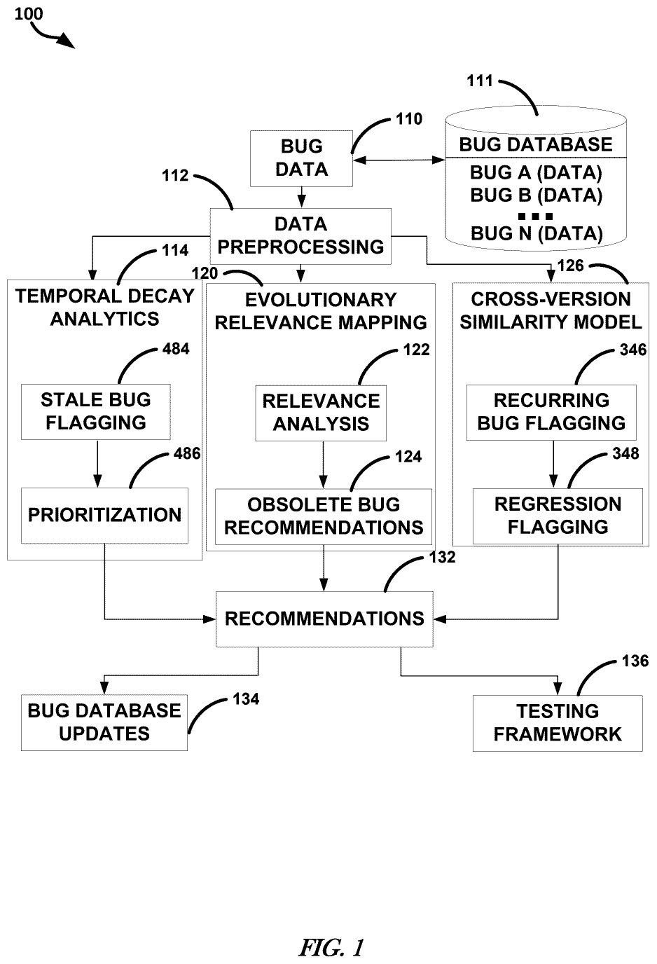

FIG. 1 illustrates, by way of example, a diagram of an embodiment of a method 100 for stale bug detection and bug mitigation.

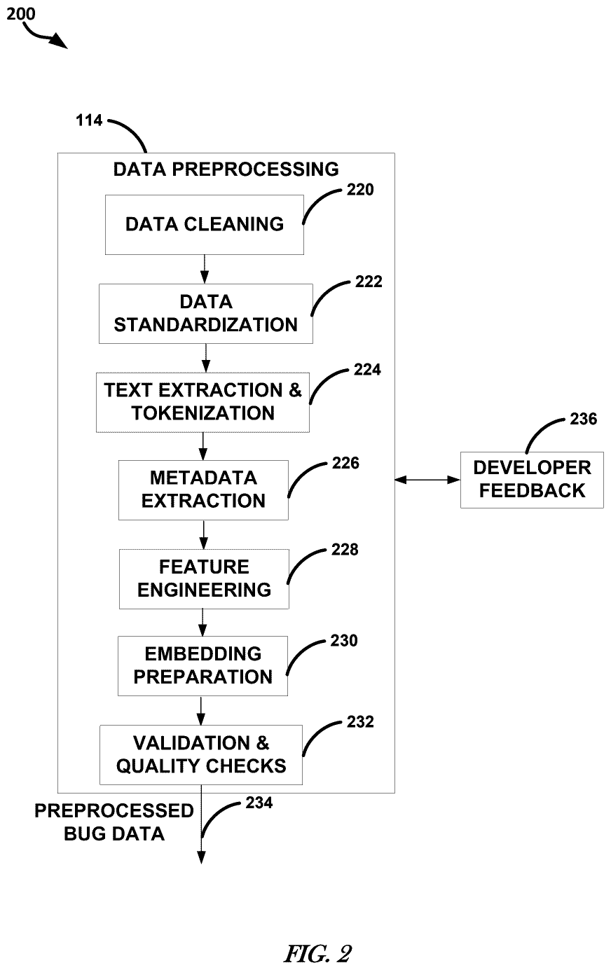

FIG. 2 illustrates, by way of example, a diagram of an embodiment of a method for dynamically preprocessing data.

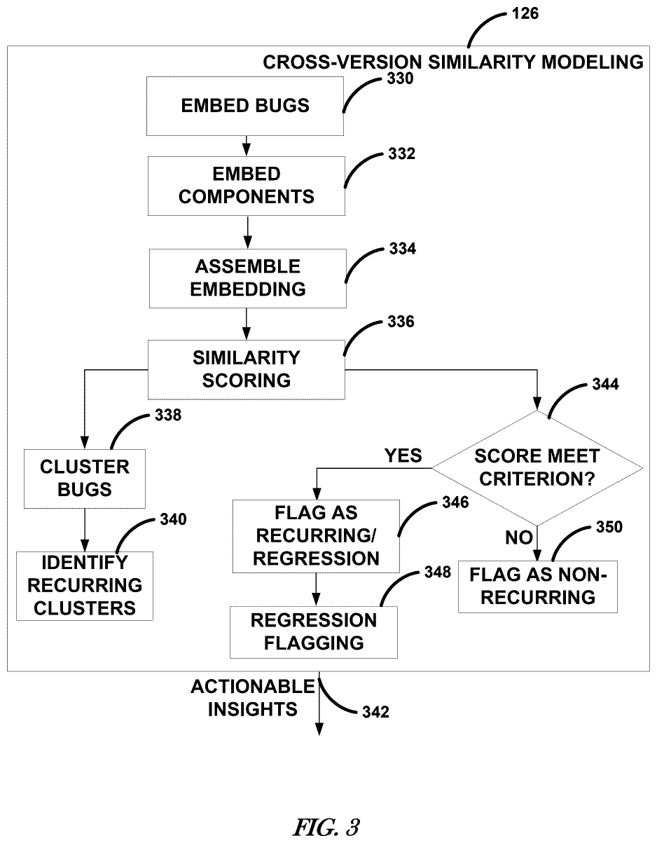

FIG. 3 illustrates, by way of example, a more detailed diagram of the cross-version similarity modeling operation.

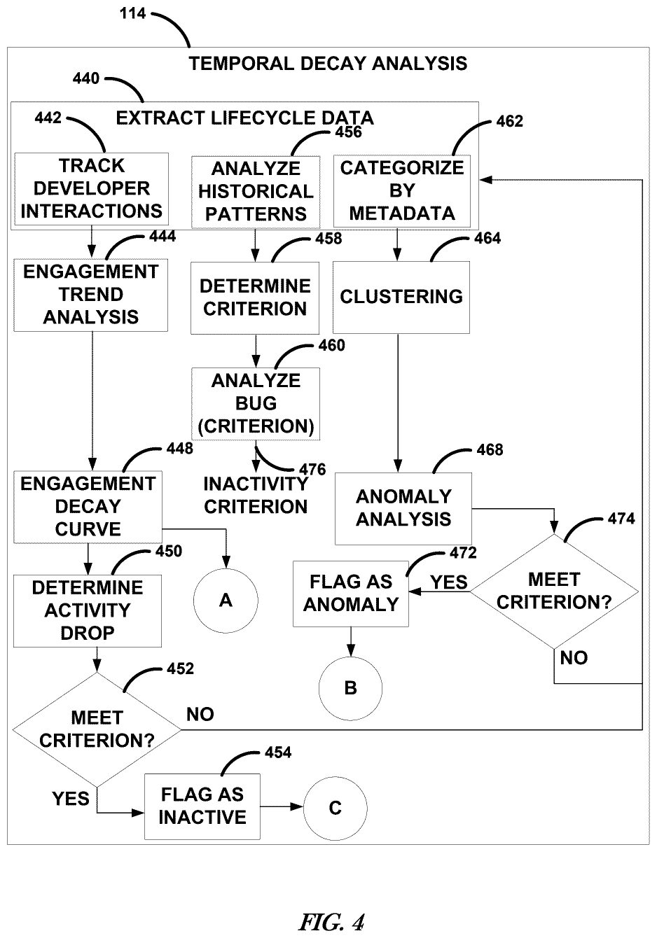

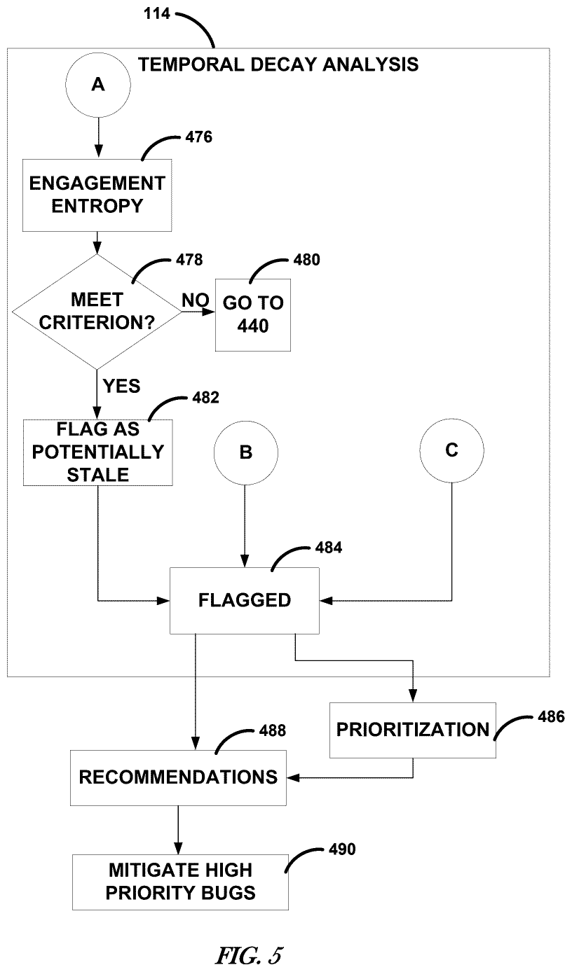

FIGS. 4 and 5 jointly illustrate, by way of example, a more detailed diagram of the temporal decay analysis (TDA) operation.

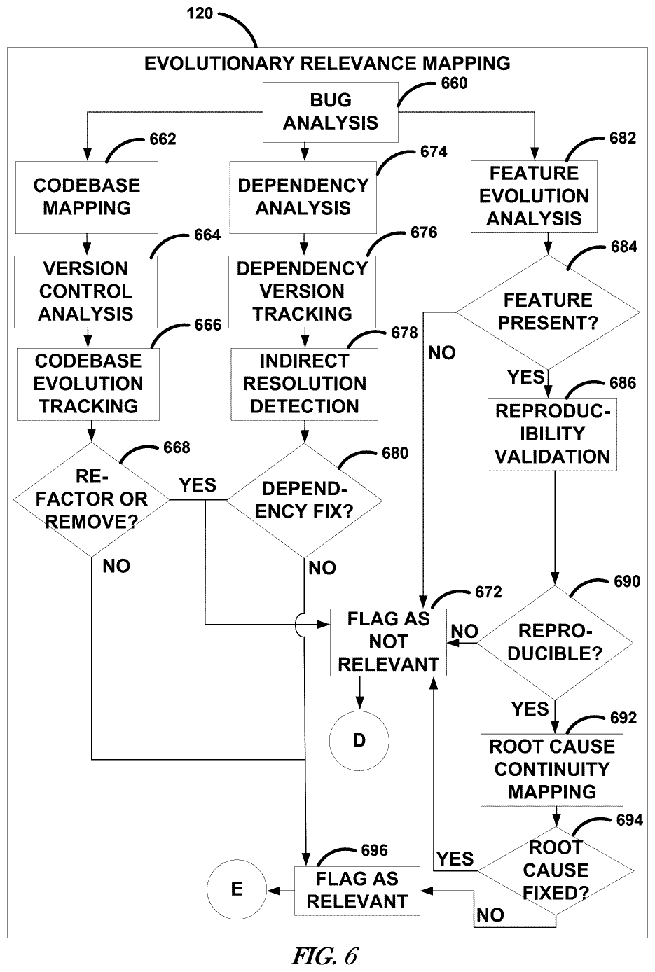

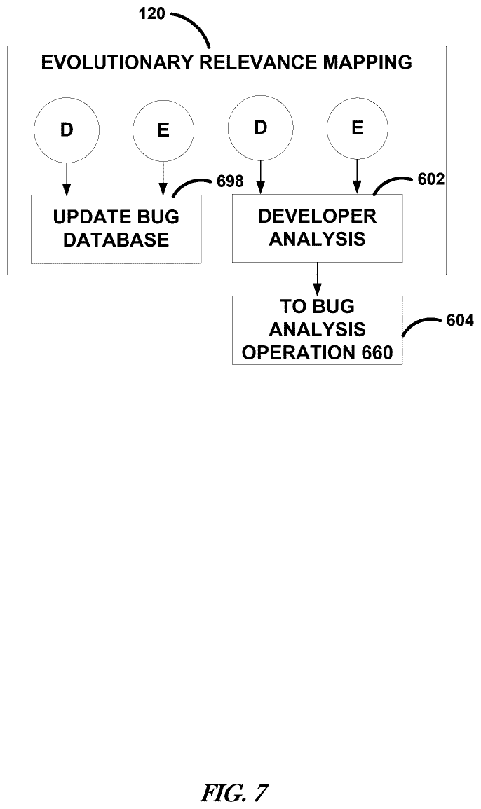

FIGS. 6 and 7 illustrate, by way of example, portions of an evolutionary relevance mapping (ERM) operation.

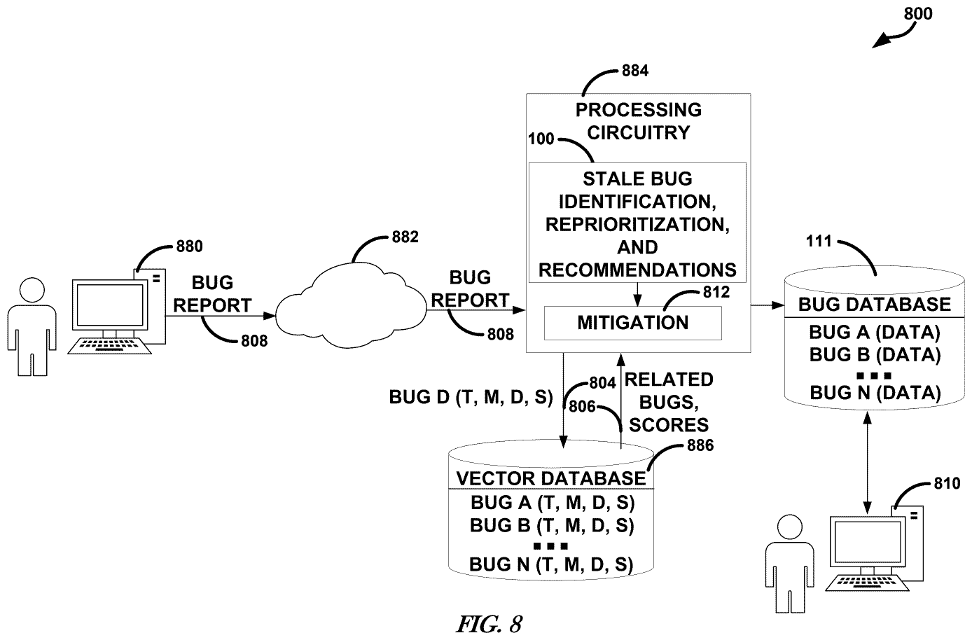

FIG. 8 illustrates, by way of example, a diagram of an embodiment of a system to implement the method of FIG. 1 or a portion thereof.

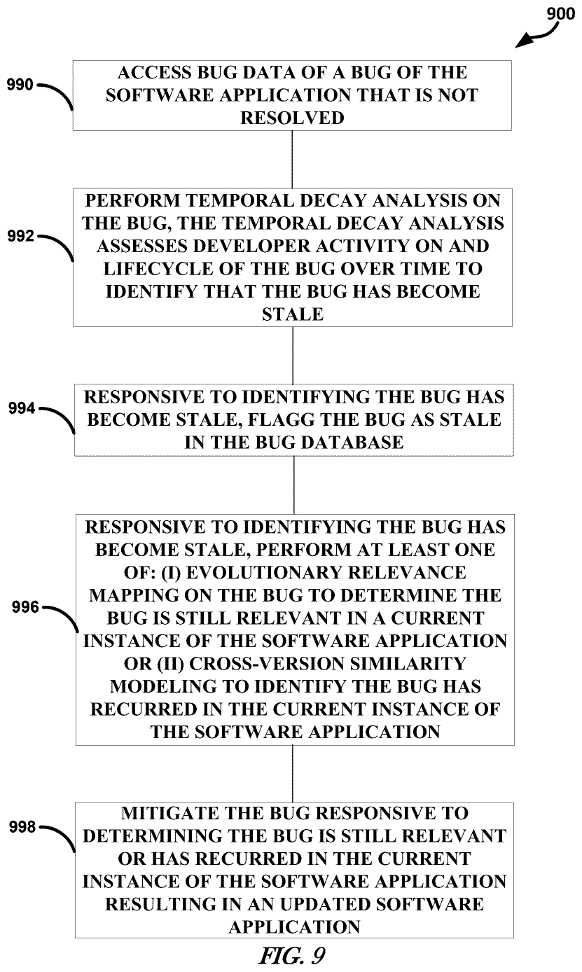

FIG. 9 illustrates, by way of example, a diagram of an embodiment of a method for stale bug identification and mitigation.

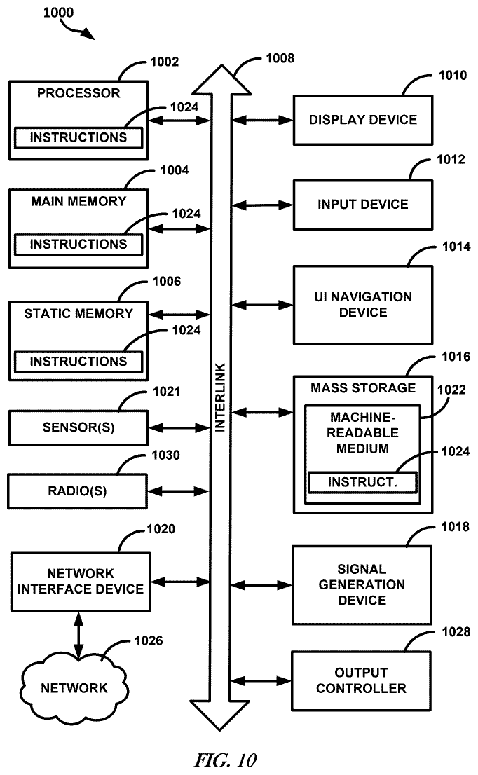

FIG. 10 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Aspects of the application relate to the field of software quality assurance and defect management. Embodiments focus on intelligent systems for identifying, categorizing, and prioritizing stale bugs in large-scale bug tracking systems. By integrating advancements in natural language processing (NLP), temporal analytics, and software evolution tracking, embodiments address critical challenges in maintaining efficient and effective bug repositories.

The accumulation of unresolved or inactive bug reports—commonly referred to as stale bugs—creates significant challenges in modern software development. These challenges include repository clutter, wasted resources, missed recurrence patterns, static and oversimplified identification, and manual effort and oversight.

Regarding repository clutter, stale bugs accumulate in bug tracking systems, obscuring active and high-priority issues, leading to inefficiency in issue triaging and management. The stale bugs can be already addressed or remain unaddressed.

Regarding wasted resources, developers often revisit outdated bugs that are no longer relevant. The outdated bugs can be addressed due to changes in software versions, architecture changes, or dependency changes, wasting valuable developer time.

Regarding missed recurrence patterns, stale bugs are frequently re-reported in newer software versions, signaling unresolved root causes or regressions. Without effective tracking, these patterns often go unnoticed.

Regarding static and oversimplified identification, existing stale bug detection methods rely on fixed inactivity thresholds (e.g., “no updates for X days”, or the like) or simplistic heuristics. The fixed inactivity thresholds or simple heuristics fail to account for an evolving context, priority, or relevance of the bug in newer versions.

Regarding manual effort and oversight, many bugs are manually reviewed. The manual effort required to review and classify stale bugs is resource-intensive and prone to errors. The manual effort results in overlooked critical issues and mismanagement of priorities.

Current stale bug management solutions have many issues. These issues include one or more of static rules for stale bug detection, lack of cross-version tracking, inadequate contextual relevance assessment, and over-reliance on manual triaging.

Regarding static rules for stale bug detection, current solutions rely on predefined rules such as inactivity thresholds. The inactivity thresholds do not adapt to the unique lifecycle characteristics of each bug or the development phase of the software.

Regarding a lack of cross-version tracking, existing tools fail to connect unresolved bugs across software versions. The failure to connect unresolved bugs across software versions misses opportunities to identify recurring issues or regressions caused by unresolved root causes.

Regarding inadequate contextual relevance assessment, current systems do not account for the impact of evolving software environments, such as refactored codebases, feature updates, or dependency changes, on the relevance or resolution status of stale bugs.

Regarding an over-reliance on manual triaging, software developers and quality assurance teams must manually evaluate whether stale bugs are still relevant. This manual triaging is inefficient and introduces the risk of misclassification or oversight.

Embodiments overcome the limitations of existing solutions by introducing a multi-layered, adaptive framework that combines innovative techniques in bug similarity detection, lifecycle modeling, and contextual relevance mapping. Embodiments can use two or more of the following innovations to improve stale bug detection:

Dynamic Adaptation: Embodiments can replace static, rule-based stale bug detection with adaptive, machine-learning-driven models that analyze bug lifecycle patterns, engagement entropy, and contextual relevance.

Cross-Version Analytics: Embodiments can incorporate advanced semantic embedding techniques and version-aware context modeling.

Embodiments can identify recurring bugs or regressions across software versions, even when the recurring bugs or regressions manifest with subtle differences.

Context-Aware Relevance Tracking: Embodiments can evaluate the impact of software evolution (e.g., refactored code, dependency updates, or the like) on stale bugs, determining whether they remain relevant, have been indirectly resolved, or are obsolete.

Automated Prioritization and Recommendations: Embodiments can minimize a manual effort by automating the prioritization, reassignment, and resolution recommendations for stale bugs, ensuring that critical issues receive attention without cluttering the repository with irrelevant reports.

By addressing at least some of the challenges of existing solutions, embodiments establish a novel, intelligent approach to stale bug management, ensuring that defect triaging processes remain efficient, adaptive, and focused on high-impact issues in modern, rapidly evolving software ecosystems. Embodiments are an intelligent stale bug detection and prioritization system that uses advanced analytical frameworks and machine learning to overcome the limitations of existing solutions.

FIG. 1 illustrates, by way of example, a diagram of an embodiment of a method 100 for stale bug detection and bug mitigation. The method 100 as illustrated includes retrieving or receiving bug data at operation 110. The bug data can be retrieved from or received from the database 111. The database 111 provides a source of raw bug reports. Bug reports can include a title, description, error log, stack trace, a combination thereof, or the like. The bug data can be for bugs that have been mitigated and bugs that remain unmitigated (are active). The bug database 111 can be populated automatically by users submitting bug reports through a host website, developer upload, or a combination thereof.

At operation 112, the bug data from operation 110 is preprocessed. Three parallel operations are illustrated as operating on preprocessed data from operation 110. The parallel operations are temporal decay analytics at operation 114, evolutionary relevance mapping, at operation 120, and cross-version similarity modeling at operation 126. Each of the operations 112, 114, 120, and 126 are described in more detail regarding FIGS. 2, 4 and 5, 6- and 7, and 3, respectively. These FIGS. will now be described, and then the remainder of FIG. 1 will be described as the remainder of FIG. 1 depends on the output of the operations 114, 120, and 126.

FIG. 2 illustrates, by way of example, a diagram of an embodiment of a method 200 for dynamically preprocessing data. The method 200 as illustrated includes the data preprocessing operation 114. The data preprocessing operation 114 includes preparing raw bug data by cleaning, extracting metadata, and creating embeddings for analysis.

The data preprocessing operation 114 includes data cleaning at operation 220, data standardization at operation 222, text extraction and tokenization at operation 224, metadata extraction at operation 226, feature engineering at operation 228, embedding preparation at operation 230, and validation and quality checks at operation 232. Developer feedback 236 provides adjustments to the thresholds or techniques used to perform the data preprocessing of the operation 114.

The data cleaning operation 220 can remove redundant or duplicate information from the bug data (received at operation 110). The data cleaning operation 220 can remove null values from the bug data. The data cleaning operation 220 can remove noise from the bug data (e.g., by removing outlier data). The data cleaning operation 220 can discard a bug report that does not include sufficient information to perform one or more of the operations 114, 120, 126.

The data standardization operation 222 can normalize formats of the bug data. The data standardization operation 222 can normalize units of the bug data. The data standardization operation can standardize fields, such as timestamps, version naming, a combination thereof, or the like of the bug data.

The text extraction and tokenization operation 224 can extract features from the text of the bug data. The text extraction and tokenization operation 224 can tokenize text fields, such as a title, description, log, stack trace, or the like.

The metadata extraction operation 226 can extract a priority, severity, version information, a combination thereof or the like, from the bug data. The metadata extraction operation 226 can extract platform, operating system (OS), or other environment information.

The feature engineering operation 228 can generate derived features and context (as compared to tokenized text fields). A derived feature is not express and is the result of one or more operations. Derived features can include time decay, bug engagement trend, a combination thereof, or the like.

The embedding preparation operation 230 prepares data for an embedding model. The embedding preparation operation 230 formats data into a format that is used by an embedding model.

The validation and quality check operation 232 ensures data integrity and completeness. The validation and quality check operation 232 checks for missing values, inconsistencies in the bug data or features, or the like.

The result of the data processing operation 114 is preprocessed bug data 234. The preprocessed bug data 234 can be used by the operations 114, 120. 126, or the like. An example of preprocessing data from a bug report is now provided:

### Example Raw Bug Report

Title: “Calendar sync causes app to freeze!!!”
Description: “App freezes during calendar sync on iOS16 unpredictably with large events.”
Priority: “HIGH”
Platform: “iOS 16, iPhone 13”
Logs: “OOMError @iLn=138 CalendarSyncManager.JAVA”

### Data Preprocessing Steps

### 1. Data Cleaning at Operation 220

Excess punctuation and inconsistent formatting removed.

### Result:

Title: “Calendar sync causes app to freeze.”
Logs: “OutOfMemoryError at line 138 in CalendarSyncHandler.java.”

### 2. Data Standardization at Operation 222

Dates reformatted, standardized priority.

### Result:

Platform: “iOS 16.0 Stable—iPhone 13”
Priority: “High (3/5)”
Severity: “Critical (10/10)′

### 3. Text Tokenization at Operation 224

Text broken into tokens for NLP models.

### Result:

Tokens: [“Calendar”, “sync”, “freeze”, “iOS”]
Metadata: [Priority: 3, Severity: 10, Platform: iOS 16]

### 4. Feature Engineering at Operation 226

Calculated derived fields such as bug age and engagement.

### Result:

Bug Age: “60 days”
Last Update: “45 days ago”
Relevance Score: “85/100”

### 5. Embedding Preparation at Operation 230

Text embeddings (NLP) and metadata combined.

### Result:

Final Vector: [Title Embedding, Description Embedding, Logs Embedding, Metadata Vector]

### Processed Bug Example

| Field | Value |
|---|---|
| Title | “Calendar sync causes app to freeze.” |
| Priority | “High (3/5)” |
| Severity | “Critical (10/10)” |
| Logs | “OutOfMemoryError at line 138 . . .” |
| Bug Age | “60 days” |
| Platform | “iOS 16.0 Stable - iPhone 13” |
| Derived Features | Engagement Decay = 0.3, Relevance = 85 |
| Embedding Vector | [780-dimensional vector] |

FIG. 3 illustrates, by way of example, a more detailed diagram of the cross-version similarity modeling operation 126. The cross-version similarity modeling operation 126 identifies recurring bugs or regressions across software versions using semantic embeddings and clustering.

The cross-version similarity modeling operation 126 as illustrated includes a bug embedding operation 330, a component embedding operation 332, an assemble embedding operation 334, a similarity scoring operation 336, a bug clustering operation 338, an identify recurring clusters operation 340, a comparison operation 344, a flag as recurring/regressing operation 346, and a flag as non-recurring operation 350.

The bug embedding operation 330 embeds features of the bug data into an embedding space. The embedding operation can be performed by a transformer-based natural language processing (NLP) model, such as BERT, GPT, Sentence-BERT, or the like. The bug embedding operation 330 can embed textual data of the bug data. The bug embedding from the operation 330 can capture the semantic meaning of the bug title, description, or a combination thereof.

The bug component embedding operation 332 embeds metadata (e.g., software version, platform, bug severity, or the like). The bug component embedding operation 332 can be performed by a specialized transformer model, such as CodeBERT, a graph neural network (GNN), or the like. The operation 332 can extract functional and structural patterns of error logs, stack traces, or a combination thereof.

The assemble embedding operation 334 can produce a single embedded feature vector from the outputs of the bug embedding operation 330 and the bug component embedding operation 332. The assemble embedding operation 334 can include concatenating the embedded feature vectors from the operations 330, 332 resulting in a complete feature vector.

At operation 336, similarity scores are determined based on the complete feature vector from the operation 334. The similarity scoring operation can include an angular distance, cosine similarity, or the like.

The cluster bugs operation 338 performs bugs clustering based on the similarity scores determined at operation 336. The cluster bugs operation 338 can include density-based spatial clustering of applications with noise (DBSCAN), hierarchical clustering, or the like.

Recurring clusters can be identified at operation 340. The recurring clusters are bugs that are members of the same cluster but have different software versions.

The comparison operation 344 can include comparing the similarity scores to a specified criterion, such as a threshold similarity score. If a similarity score meets or exceeds the specified criterion, the bugs can be analyzed to determine whether they are recurring at operation 346. The bugs that meet or exceed the specified threshold can also be analyzed to determine if they are regressive at operation 348. A recurring bug is a bug that was identified in a prior software version and not resolved and that appears in a later software version. A regressive bug is a bug that was identified in a prior software version and marked as resolved and that appears again in a later software version.

If the similarity score does not meet or exceed the specified criterion, the bugs can be flagged as non-recurring at operation 350. Flagging the bugs, such as at operations 346, 350, or other flagging operation. can include associating the bugs, in the database 111 with one or more flag bits. A value of the flag bits can indicate whether the bug is recurring, regressive, non-recurring, or the like.

The operation 126 is now summarized and an example of performing the operations are now provided. Cross-version similarity modeling (CVSM) is a component that enables the identification of recurring bugs or unresolved regressions across different software versions. CVSM leverages vector embeddings of historical bug reports, metadata (e.g., software version, platform, severity), and a similarity scoring mechanism to track whether stale bugs from older versions persist or resurface in newer versions, either in identical or altered forms.

CVSM can detect exact duplicates of bugs and also identify semantic and functional similarities that may indicate an unresolved root cause manifesting differently in newer contexts. This approach ensures that recurring/regressive issues are flagged proactively, preventing redundancies and regressions from being overlooked.

CVSM creates a version-aware bug embedding representation. Using the operations 330, 332 each bug report is transformed into a high-dimensional vector embedding that captures its semantic, functional, and contextual information. The embedding can be constructed using title and description embeddings (T and D), error log and stack trace embedding (E), a metadata vector (M), or a combination thereof. The metadata vector can be determined by the operation 332 or 334. The metadata vector encodes additional contextual information such as software version (V), which can be encoded using one-hot encoding or embeddings for version hierarchy (e.g., version 1.0, 1.1, 2.0), platform (P), which can include OS and device information (e.g., iOS, Android), priority and severity(S) Encoded as categorical or numerical values, a combination thereof, or the like. The bug embedding B can represented as a concatenation of these components as assembled by the operation 334 where B=[T,D,E,M].

The operation 336 generates similarity scores for pairs of bugs that can be compared across bugs across versions. The similarity score can be determined between the embedding of a stale bug from an older version and the embeddings of bugs reported in newer versions. The similarity score S between two bug embeddings Bi and Bj can be computed as a weighted sum of cosine similarity across the different embedding components:

$$S ( {B}_{i} , {B}_{j} ) = {λ}_{t} \cdot cosine ( {T}_{i} , {T}_{j} ) + {λ}_{d} \cdot cosine ( {D}_{i} , {D}_{j} ) + {λ}_{e} \cdot cosine ( {E}_{i} , {E}_{j} ) + {λ}_{m} \cdot cosine ( {M}_{i} , {M}_{j} )$$

Where λₜ, λ_{d}, λₑ, λₘ are weights assigned to the title, description, error log, and metadata similarity, respectively. These weights are tuned based on the importance of each component in the specific software context. cosine(X,Y) is a cosine similarity function, which measures an angular similarity between two vectors X and Y.

The operation 344 can include threshold-based matching, such as to determine whether two bugs are similar. The similarity score S(Bi, Bj) can be compared to a predefined threshold θ:

$$Match ( {B}_{i} , {B}_{j} ) = \{ \begin{matrix}1 & if S ( {B}_{i} , {B}_{j} ) \geq θ \\ 0 & if S ( {B}_{i} , {B}_{j} ) < θ\end{matrix}$$

θ is the similarity threshold. The similarity threshold can be dynamically tuned based on feedback, precision-recall trade-offs, or the like.

The operation 338 can include clustering across versions of the bug. To identify clusters of recurring or unresolved bugs, one or more clustering algorithms (e.g., hierarchical clustering or DBSCAN) can be applied based on the similarity scores. Bugs that form a cluster across versions can be flagged as a recurring or regressive issue.

An example of the CVSM operation 126 is now provided. Consider the following scenario in which a bug is reported in versions 1.0 and 2.0 of a software application.
Bug report reported in version 1.0:
Title: “App crashes when syncing calendar.”
Description: “The app crashes during calendar sync on iOS.”
Error Log: NullPointerException in CalendarSyncHandler.java.
Version: 1.0.
Bug reported in version 2.0:
Title: “Calendar sync causes app to freeze.”
Description: “The app freezes when syncing large calendar events on iOS 16.”
Error Log: OutOfMemoryError in CalendarSyncHandler.java.
Version: 2.0.
Embeddings can be generated and assembled at operations 330, 332, 334.
For the bug in version 1.0: B1=[T1,D1,E1,M1]
T1: Embedding of “App crashes when syncing calendar.”
D1: Embedding of “The app crashes during calendar sync on iOS.”
E1: Embedding of NullPointerException in CalendarSyncHandler.java.
M1: Metadata embedding for version 1.0 and iOS.
For the bug in version 2.0: B2=[T2,D2,E2,M2]
T2: Embedding of “Calendar sync causes app to freeze.”
D2: Embedding of “The app freezes when syncing large calendar events on iOS 16.”
E2: Embedding of OutOfMemoryError in CalendarSyncHandler.java.
M2: Metadata embedding for version 2.0 and iOS.

The similarity score is then determined at operation 336. Similarity score can be determined using the similarity formula:

$$S ( {B}_{1} , {B}_{2} ) = {λ}_{t} \cdot cosine ( {T}_{1} , {T}_{2} ) + {λ}_{d} \cdot cosine ( {D}_{1} , {D}_{2} ) + {λ}_{e} \cdot {cosine E}_{1} , {E}_{2} ) + {λ}_{m} \cdot cosine ( {M}_{1} , {M}_{2} )$$

Assume that λₜ=0.3, λ_{d}=0.3, λₑ=0.3, λₘ=0.1. Resulting similarity values are then cosine(T₁, T₂)=0.85, cosine(D₁, D₂)=0.80, cosine(E₁, E₂)=0.90, cosine(M₁, M₂)=0.95. The resulting similarity score is

S(B₁,B₂)=(0.3·0.85)+(0.3·0.80)+(0.3·0.90)+(0.1·0.95)=0.255+0.24+0.27+0.095=0.86

At operation 344, the similarity score is compared to a specified criterion. Assume the similarity threshold θ=0.85. Since S(B₁, B₂)=0.86, the two bugs are deemed similar.

At operation 338, the bugs can be clustered based on their similarity scores and their complete embedded feature vectors. The two bugs (from version 1.0 and version 2.0) can be clustered into a single group. The bugs can thus be flagged, at operation 340, as a recurring issue.

An actionable insight 342 from the operation 126 can include information indicating whether the bug is recurring, regressive, has a same root cause, or a combination thereof. If the bug in version 1.0 was marked as resolved, but a similar bug appears in version 2.0, the bug can be flagged as a potential regression at operation 348. By analyzing the error logs and metadata, the system identifies that both bugs are related to the same root cause in CalendarSyncHandler.java.

Pre-trained models like BERT, CodeBERT, or Sentence-BERT can be adapted for Cross-Version Similarity Modelling (CVSM) rather than being used out of the box. For example, these models can be fine-tuned, include metadata-enriched embeddings, and specialized models can be used for log analysis.

### 1. Fine-Tuning on Bug Data

Models can be fine-tuned using historical bug reports to learn domain-specific terminology (e.g., “OOMError”) and bug patterns. Fine-tuning improves detection of subtle similarities (e.g., “freeze” vs. “unresponsive”).

### 2. Metadata-Enriched Embeddings

Instead of just text, embeddings can include metadata (e.g., priority, severity, platform, version).

Example:

$$B = [ Title Embedding , Description Embedding , Error log Embedding , Metadata Vector ]$$

### 3. Weighted Scoring

Components of similarity (title, logs, metadata) can be weighted differently.

### Example:

$$S ( {B}_{i} , {B}_{j} ) = {λ}_{t} \cdot T + {λ}_{d} \cdot D + {λ}_{e} \cdot E + {λ}_{m} \cdot M$$

Weights (λ) are tuned for better precision and recall.

### 4. Clustering for Recurring Bugs

Pairwise similarity transforms into many-to-many clustering (e.g., DBSCAN) to group bugs across versions.

### 5. Version-Aware Context

Embeddings include version data so bugs in v1.0 vs. v2.0 are compared contextually.

### Example:

$$B = [ Transfomer - Encoding , Version Encoding ]$$

### 6. Specialized Models for Logs

CodeBERT or Graph Neural Networks (GNNs) process error logs and stack traces better than generic models.

### Summary of Changes

| Aspect | Original | Modified |
|---|---|---|
| Bug Learning | Pre-trained | Fine-tuned on bug |
| | models | reports/logs. |
| Embeddings | Text-based | Text + metadata |
| | | (priority, version). |
| Similarity | Basic cosine | Weighted + dynamically |
| Scoring | similarity | tuned scoring. |
| Output | Pairwise | Cluster recurring bugs |
| | results | (cross-version). |
| Programming | Text-only | Code-specific models |
| Context | | for logs and traces. |

Pre-trained models can be enhanced for CVSM with fine-tuning, metadata enrichment, and version/context-aware adjustments to maximize relevance in bug tracking.

FIGS. 4 and 5 jointly illustrate, by way of example, a more detailed diagram of the temporal decay analysis (TDA) operation 114. The TDA operation 114 assess the activity and lifecycle of bugs over time to identify those that have become stale. The TDA operation 114 dynamically evaluates bug lifecycles using engagement trends, custom inactivity thresholds, and lifecycle anomaly detection.

TDA uses programming to automate the detection of stale bugs. TDA tracks activity trends, calculates dynamic inactivity thresholds, and analyzes engagement patterns using algorithms like time-series analysis and decay curves. TDA is designed to adaptively identify stale bugs based on real-time data rather than relying on static rules.

Unlike static inactivity thresholds (e.g., “no updates for 90 days”), the TDA operation 114 incorporates dynamic, bug-specific factors, such as engagement trends, historical resolution patterns, and lifecycle anomalies to determine whether a bug has truly become inactive or requires further attention. This ensures that bugs are classified as stale based on their unique characteristics and not arbitrary time thresholds. The operation 114 includes evaluating bug lifecycles using engagement trends, custom inactivity thresholds, and lifecycle anomaly detection.

The TDA operation 114 monitors developer and system interactions with each bug over time to understand its lifecycle activity. The understanding of lifecycle activity includes extracting lifecycle data at operation 440. The operation 440 includes determining tracking developer interactions at operation 442, analyzing historical patterns are operation 456, and categorizing by metadata at operation 462. Developer interactions, at operation 442 include developer comments or updates, status changes (e.g., “New”-> “In Progress”), assignments or reassignments to team members, code commits referencing the bug, a combination thereof, or the like.

At operation 444, engagement activity (sometimes called developer interactions) is tracked and plotted over time. A result of the operation 444 is an engagement decay curve 448. The decay curve 448 models the decline in engagement with the bug (if there is any decline in engagement). At operation 450, the amount of engagement decline in the bug is quantified. The amount of engagement decline is compared to a specified criterion at operation 452. If the engagement meets the specified criterion of engagement over time, the bug is flagged as potentially stale at operation 454. If the engagement does not meet the specified criterion of engagement over time, a next bug is analyzed at operation 440.

An example of the operation 442, 444, 448, 450, 452, 454 is now provided. Consider the following series of developer engagement events associated with a bug report:
Day 1: Commented on by a developer.
Day 3: Marked as “In Progress.”
Day 7: Another comment is added.
After Day 7: No further activity for 60 days.

The TDA operation 114 detects the sharp drop in engagement and flags this bug as stale.

The engagement decay curve 448 is a temporal decay curve. The TDA operation 114 can use the temporal decay curve to model the likelihood of a bug being actively worked on over time. The decay curve represents how the probability of resolution decreases as time progresses without engagement. At operation 444, engagement trend analysis is performed to determine, for example, that a bug starts with a high likelihood of resolution (e.g., 100%) upon creation. As time passes without engagement, the likelihood decays based on historical patterns. This results in the engagement decay curve 448. When the probability drops below a threshold, the inactivity criterion 476, the bug is flagged as stale at operation 454. Consider an example Bug E with the following temporal series of likelihoods of resolution and flagging:
Day 0: 100%.
Day 10: 80% (due to developer engagement).
Day 30: 40% (no updates since Day 10).
Day 60: 10% (threshold reached, flagged as stale).

The TDA operation 114 can adjust the decay rate and thresholds based on contextual factors. The contextual factors can be identified at operation 458. The contextual factors can include development phase of the bug, importance of the features of the bug, or a combination thereof. For the development phase, bugs in beta releases decay faster due to shorter cycles, while bugs in stable releases decay slower. For the feature importance, bugs in critical features (e.g., authentication, payment systems) decay slower than those in less critical areas (e.g., UI animations). For example a bug with a feature indicating it is associated with a payment system has a slow priority decay rate so that the priority remains higher for longer. In another example, a bug with a feature indicating it is associated with UI animation has a decay rate that is relatively faster since it is lower priority, the decay accelerates faster over time.

Inactivity criterion 476, used in the operation 452, can be dynamic. Instead of using a static rule (e.g., “inactive for 90 days”), the TDA operation 114 can adjust the inactivity threshold dynamically based on: bug priority, bug severity, historical resolution patterns, a lifecycle stage of the bug, or a combination thereof.

At operation 456, the historical patterns of the bug can be analyzed. Bugs in similar categories (e.g., user interface (UI) bugs, backend crashes, or the like) are analyzed to determine typical resolution times.

At operation 458, the bug priority, severity, history, and lifecycle stage can be analyzed to determine criterion for different categories of bugs. High-priority bugs are expected to have quicker resolution timelines compared to low-priority ones. Bugs in early-stage software releases (e.g., alpha, beta) may require shorter thresholds due to faster iteration cycles. The typical resolution times for historical bugs can provide a basis for setting bug activity thresholds (or bug inactivity thresholds).

At operation 460, the criterion determined at operation 458 are applied to a given bug to determine the inactivity criterion 476 for that specific bug. An example is not provided to help illuminate how the inactivity criterion 476 is determined.

In the TDA operation 114, a custom inactivity criterion 476 is determined for each bug based on attributes of the bug. If activity on resolving the bug drops below a threshold, it is flagged as stale at operation 454. Consider a high priority Bug A and a low priority Bug B with the following attributes:

### Bug A (High-Priority):

Typical resolution time for high-priority bugs is 15 days.
Custom inactivity threshold: 20 days.
If Bug A sees no updates for 21 days, it is flagged as stale.

### Bug B (Low-Priority):

Typical resolution time for low-priority bugs is 60 days.
Custom inactivity threshold: 90 days.
Bug B is flagged as stale only after 91 days of inactivity.

Operations 462, 464, 468, 474, and 472 are part of lifecycle anomaly detection. The TDA operation 114 can use machine learning (ML) (e.g., time-series models) to detect anomalies in a bug's lifecycle. The ML model can compare the activity timeline of the bug with historical patterns of similar bugs (e.g., same feature area, priority, type, or a combination thereof). To perform this, at operation 462, the bugs are categorized by metadata (e.g., features, priority, type, or the like).

At operation 464, bugs are clustered based on the metadata (e.g., type, features, severity). The clustering can include DBSCAN, hierarchical clustering, a combination thereof, or the like. At operation 468, the timelines for bugs in the same cluster are compared and differences between the timelines are compared. If any of the differences meet a specified criterion, at operation 474, the bug is flagged as a lifecycle anomaly (potentially stale). If none of the differences meet the specified criterion, the operation 114 begins again with another bug.

Consider lifecycle anomaly detection in light of an example in which:

Historical data shows that authentication-related bugs are typically resolved within 10 days.

Bug C (related to authentication) remains unresolved for 25 days with no updates.

The TDA operation 114 flags Bug C as a lifecycle anomaly, prompting developers to investigate.

FIG. 5 illustrates a portion of the TDA operation 114 that includes engagement entropy analysis at operations 476, 478, and 482. The TDA operation 114 can use an engagement entropy metric to measure the consistency of interactions over time. The engagement entropy can be determined at operation 476. High entropy indicates irregular or sporadic engagement, which may signal that the bug is becoming stale. The entropy is compared to a specified criterion at operation 478. If the entropy meets or exceeds the criterion the bug is flagged as stale, at operation 482. If the entropy does not meet or exceed the specified criterion, the operation 114 begins again with another bug.

The engagement entropy is calculated, at operation 476, based on the frequency and distribution of interactions with the bug over time. Bugs with declining and erratic engagement patterns are flagged as potential candidates for staleness at operation 482. Consider an example Bug D with the following engagement history:
Day 1: Commented on.
Day 5: Assigned to a developer.
Day 10: Status changed to “In Progress.”
Day 20: No updates.
Day 50: Comment added by another developer.
Day 100: No further updates.

The sporadic nature of engagement (high entropy) leads the TDA operation 114 to flag Bug D as stale.

At operation 484, the bugs that are flagged as potentially stale, based on engagement trends, engagement entropy, lifecycle anomaly, or a combination thereof are identified. The flagged bugs are prioritized at operation 486. Bugs with higher priorities, as can be determined at operation 458, can be prioritized over bugs with lower priorities. Bugs associated with newer software can be prioritized over bugs associated with more mature software. Bugs associated with more important portions of software (e.g., authentication, home screens, or the like) can be prioritized over bugs associated with less important portions of the software (e.g., a more niche function of the software that is used by fewer users).

Recommendations are then provided at operation 488. The recommendations include actions to be performed on highest priority bugs. At operation 490, the recommendations can be followed to mitigate a high priority stale bug.

An end-to-end example of the TDA operation 114 performance is now provided. Consider the bug report:
Title: “App crashes when uploading files.”
Description: “The app crashes intermittently when uploading files larger than 10 MB.”
Priority: Medium.
Created On: Jan. 1, 2023.
Last Engagement: Jan. 10, 2023.
Category: File Upload Module.

Engagement trend analysis, the operations 442, 444, are then performed. The TDA operation tracks the following interactions:
January 1: Bug created.
January 2: Comment added by a developer.
January 5: Status changed to “In Progress.”
January 10: Last comment added.
After January 10, no further updates are recorded.

The inactivity criterion 476 are determined. Based on medium priority and historical resolution patterns for file upload bugs:
Typical resolution time: 20 days.
Custom inactivity threshold: 30 days.
By February 10 (30 days of inactivity), the bug exceeds its threshold.

Lifecycle anomaly detection is performed. The system compares this bug to historical file upload bugs:
90% of similar bugs are resolved within 20 days.
The bug is flagged as an anomaly because it remains unresolved for 40 days.

The engagement decay curve (temporal decay curve) is then created and analyzed. The decay curve shows the likelihood of resolution:
January 1: 100%.
January 10: 90% (high engagement).
February 1: 50% (no updates for 20 days).
February 10: 20% (threshold reached, flagged as stale).

The operations 484 and 488 can be performed as:

The bug is flagged as stale.

Action recommendation:
Reassign to an active developer.
Mark as a candidate for review in the next sprint.
Merge with a similar bug if identified.

FIGS. 6 and 7 illustrate, by way of example, portions of the evolutionary relevance mapping (ERM) operation 120. The ERM operation 120 is a framework that evaluates whether a bug reported in the past (particularly stale bugs) is still relevant in the current software context. The ERM operation 120 analyzes codebase evolution, dependency updates, and reproducibility to determine the current relevance of stale bugs.

The ERM operation 120 analyzes changes in the software codebase, dependencies, features, and environment over time. The ERM operation 120 helps determine whether a bug has become functionally obsolete, indirectly resolved, or remains critical due to its root cause still being valid in the current version.

The ERM operation 120 performs functional obsolescence detection. The ERM operation 120 checks whether the features, code path, or module of the bug have been deprecated, refactored, or removed in newer software versions. The ERM operation 120 includes codebase mapping at operation 662. The codebase mapping operation 662 determines which modules, functions, libraries, or the like are in each version of a software application. A version control analysis operation 664 tracks changes to the codebase using version control data (e.g., Git commit history). A codebase evolution tracking operation 666 maps specific files, functions, or modules affected by the issue to corresponding software application versions. At operation 668, it is determined whether the source of the bug is present in a later version of the application. If the source of the bug has been deprecated or refactored in the later version of the application, the bug is flagged as obsolete at operation 672. If the source of the bug has not been refactored or removed from a later version of the software application, the bug remains relevant and the functional obsolescence detection process for that flags the bug as relevant at operation 696. An example of functional obsolescence detection is now provided. Considered a bug scenario as follows:
Bug: “Dropdown menu does not render correctly.”
Associated Module: UIComponentRenderer.js.
Update: In version 2.0, the dropdown menu feature is replaced with a new Dropdown V2 component.

The ERM operation 120 flags the bug as obsolete at operation 672, since the old module no longer exists.

The ERM operation 120 can include a dependency evolution analysis. In dependency evolution analysis the ERM operation 120 evaluates whether changes in external dependencies (e.g., third-party libraries, application programming interface (APIs), or the like) have addressed or invalidated the root cause of a bug. The operations 674, 676, 678, and 680 are part of dependency evolution analysis.

A dependency analysis operation 674 determines APIs, libraries, or other 3rd party components on which the bug of the software application relies. The dependency version tracking operation 676 monitors updates to the components (e.g., third-party libraries or APIs) associated with the bug across versions (e.g., library version changes or API version changes). At operations 678 and 680, it is determined whether there is an indirect resolution of the bug. Indirect resolution of the bug includes changing a component on which the bug relies. If a library or other component update fixes the underlying issue, the bug is flagged as indirectly resolved at operation 672.

An example of the evolutionary relevance mapping 120 is now provided. Consider a bug with the following data:
Bug: “App crashes due to JSON parsing error.”
Root Cause: The bug is traced to json-lib v1.2.0.
Update: In version 2.1, the app upgrades json-lib to v1.3.0, which includes a fix for the parsing issue.

The ERM operation 120 flags the bug as indirectly resolved.

The ERM operation 120 further includes reproducibility validation and root cause continuity mapping. The reproducibility validation includes operations 682, 684, 686, 690. The root cause continuity mapping includes operation 692, 694, 696. Reproducibility validation automatically re-tests stale bugs in the context of the latest software version to determine whether the issue still exists. Root cause continuity mapping determines whether a stale bug's root cause is still valid in the current software version, even if the bug itself manifests differently.

At operation 682 features of the bug are compared to features of the current software version. Operation 684 determines whether the features of the bug are present in the current software version. If the features are no longer present in the current software, then the bug is flagged as not relevant at operation 672. If the features remain present in the current software, reproducibility validation can be performed at operation 686. At operation 686, automated test cases or simulations are executed to try to reproduce the bug in the latest version. At operation 690 it is determined whether the bug is reproducible or not. If the bug no longer reproduces, it is flagged as no longer relevant at operation 672. If the bug is reproducible, root cause continuity mapping can be performed, beginning at operation 692.

An example of reproducibility validation is now provided. Consider a bug with the following data:
Bug: “App crashes when uploading files larger than 10 MB.”
Automated Test: The system attempts to upload a 15 MB file in version 3.0.
Result: No crash observed.

The ERM operation 120 concludes the bug is no longer relevant.

In root-cause continuity mapping, a root cause of the bugs in the software versions are identified at operation 692. The root cause can include specific lines of code, dependencies, software components, or the like. At operation 694, the root causes are compared to determine if they are the same. If the root cause is unchanged (the root causes are the same), the bug is flagged as relevant at operation 696. If the root cause is changed (the root causes are different), the bug is flagged as no longer relevant.

An example of root cause continuity mapping is now provided. Consider a bug with the following data:
Bug: “Database sync fails intermittently.”
Root Cause: A race condition in SyncManager.java.
Update: The bug is inactive but the underlying race condition remains unresolved in version 3.0.

The ERM operation 120 flags the bug as still relevant and escalates it for reassessment.

At operation 698, the bug database 111 is updated to remove all bugs flagged as not relevant, resolved, or the like. At operation 698, flags of bugs that are still relevant are updated to indicate the results of the ERM operation 120. The bugs can be flagged as reproducible or not, indicate whether they have the same root cause, or the like.

Now that the operations 114, 120, and 126 have been described in more detail, the remainder of FIG. 1 is described. At operation 484, any bugs deemed inactive, stale, or the like are flagged as stale in the bug database 111. Bugs can be deemed inactive based on dynamic thresholds, decay analytics, or a combination thereof. The prioritization operation 486 re-prioritizes stale bugs based on severity, recurrence, and relevance to current software context.

A relevance analysis operation 122 determines whether bugs are functionally obsolete, indirectly resolved, or still relevant based on the flagging performed in the ERM operation 120. The relevance analysis operation 122 can include any of the operations of the ERM operation 120. An obsolete bug recommendations operation 124 suggests archiving or closing bugs deemed irrelevant, obsolete, or otherwise no longer an issue.

The recurring bug flagging operation 346 flags bugs that reappear across multiple software versions, aiding in regression tracking. The regression bug flagging operation 348 indicates unresolved bugs that reappear, signaling potential bug regressions.

A recommendations operation 132 provides automated actionable insights, such as reassignment, prioritization, or inclusion in regression test suites. A bug database update operation 134 updates the bug database 111 with insights, recommendations, and resolution statuses. A testing framework operation adds flagged regressions to automated regression test cases for validation in future releases. Developer feedback can be leveraged to refine one or more of the models or criterion, such as one or more thresholds.

An end-to-end example of the ERM operation 120 is now provided. Consider a bug with an associated bug report as:
Bug Report (Version 1.0):
Title: “App crashes during login.”
Root Cause: Null pointer exception in LoginHandler.java.
Status: No activity for 180 days (stale).
Codebase analysis (operations 662, 664, 666, 668) for Version 2.0 can execute as:
LoginHandler.java is refactored into AuthenticationManager.java.

The ERM operation 120 checks and confirms that the specific null pointer issue no longer exists.

The ERM operation 120 flags the bug as functionally obsolete at operation 672.

A dependency check (operations 674, 676, 678, 680) can execute as:

The app was using AuthLib v1.0 in version 1.0 and has now upgraded to AuthLib v2.0 in version 2.0.

The ERM operation 120 can find that AuthLib v2.0 includes a fix for the null pointer issue.

The bug can be flagged as indirectly resolved at operation 672.

Automated reproducibility test of version 2.0 (operation 686, 690) can execute as:

The ERM operation 120 runs a login test on the latest version.

Result: No crash observed.

Final Status: Bug is marked as no longer relevant at operation 672.

Automated prioritization operation 486 and action recommendations 488 can execute to re-prioritize bugs based on their recurrence patterns, relevance, and potential impact on the current software version. Bugs flagged as “stalled” by the TDA operation 114 can be automatically reassigned to an active developer or team. Bugs deemed “obsolete” or “irrelevant” can be recommended for archival or closure, with detailed justifications. Recurring or unresolved stale bugs can be added to regression test suites to ensure they are addressed in future releases.

Unique technical features of the method 100 can include:

Cross-version Awareness by integrating software version metadata into bug embeddings, the system enables precise tracking of recurring issues and regressions across updates.

Dynamic and adaptive analysis by temporal decay analytics and dynamic thresholds that help ensure that stale bug detection adapts to the unique characteristics of each bug and the software lifecycle.

ERM introduces a novel framework for evaluating the continued relevance of bugs based on changes in the software ecosystem.

Automated resolution workflow reduces manual effort by automating stale bug identification, prioritization, and action recommendations.

FIG. 8 illustrates, by way of example, a diagram of an embodiment of a system 800 to implement the method 100 or a portion thereof. The system 800 as illustrated includes a user device 880, a network 882, processing circuitry 884, a vector database 886, and the bug database 111. A user accesses functionality of a software application using the user device 880. The user produces a bug report 808 that indicates a functionality, semantic, visual presentation, or other issue with the software application. The bug report 808 includes a title, description, and corresponding metadata of the bug. The title is a high-level description of the bug, such as a single sentence summary of the bug. The description is a lower-level description of the bug including the process through which the bug realized. The metadata indicates a time/date at which the bug presented, an operating system of the user device 880, a version of the software application, whether the software application is executed locally or in the cloud, a title of the software application, a combination thereof, or the like. The bug report 808 includes reproduction steps and one or more error log entries.

The network 882, sometimes called the cloud, provides network connectivity to communicate the bug report 808 to an entity that manages the software application. The network 882 can communicate the bug report to processing circuitry 884. The processing circuitry 884 operates on the bug report 808 to perform the operations of the method 100. The processing circuitry 884 issues a query 804 to the vector database 886. The query 804 indicates features of the bug. The query 804 prompts the vector database 886 to identify bugs that are bugs similar. The vector database 886 stores a history of bugs and their corresponding features. The vector database 886 compares the features of the bug associated with the query 804 to the features of the historical bugs stored thereon. The vector database 886 provides a specified number of top matches, based on score, as comparison results 806.

The processing circuitry 884 stores data, such as flags and corresponding results of the performing the method 100 related to the bug in the bug data database 111. The bug database 111 indicates detailed data on each of the bugs. The detailed data can include the features of the bug, the bug report, the cluster to which the bug belongs, a combination thereof, or the like.

A bug mitigator can use the processing circuitry 884 or another user device 810 to mitigate one or more of the bugs by a mitigation operation 812. The bugs can be mitigated in priority order, such that a higher priority bug is mitigated before a lower priority bug. The priority of bugs can be determined per cluster or per bug, so that a cluster of higher priority bugs is mitigated before a cluster of lower priority bugs. Mitigating the bug can include altering text on a user interface, functionality of a component on a user interface, code of a software application, data on which the application relies, a combination thereof, or the like. Mitigating bugs improves user experience and even increases the security of the application, so as to reduce vulnerabilities of the application.

FIG. 9 illustrates, by way of example, a diagram of an embodiment of a method 900 for stale bug identification and mitigation. The method 900 as illustrated includes accessing, by a bug database, bug data of a bug of the software application that is not resolved, at operation 990; performing, by processing circuitry, temporal decay analysis on the bug, the temporal decay analysis assesses developer activity on and lifecycle of the bug over time to identify that the bug has become stale, at operation 992; responsive to identifying the bug has become stale, flagging, by the processing circuitry, the bug as stale in the bug database, at operation 994; responsive to identifying the bug has become stale, performing, by the processing circuitry, at least one of: (i) evolutionary relevance mapping on the bug to determine the bug is still relevant in a current instance of the software application or (ii) cross-version similarity modeling to identify the bug has recurred in the current instance of the software application, at operation 996; and mitigating the bug responsive to determining the bug is still relevant or has recurred in the current instance of the software application resulting in an updated software application, at operation 998.

The operation 992 can include engagement trend analysis including generating, by aggregating engagement data with the bug, an engagement trend curve indicating developer engagement with the bug over time, determining, by comparing data of the engagement trend curve to first specified criterion, the developer engagement meets the first specified criterion, responsive to determine the developer engagement meets the first specified criterion, flagging the bug as stale, or a combination thereof.

The operation 992 can include engagement entropy analysis including generating an engagement trend curve indicating developer engagement with the bug over time, determining, based on the engagement trend curve, an engagement entropy, determining the engagement entropy meets second specified criterion, responsive to determine the engagement entropy meets the second specified criterion, flagging the bug as stale, or a combination thereof.

The operation 992 can include lifecycle pattern analysis including generating an engagement trend curve indicating developer engagement with the bug over time, clustering the bug with other bus based on their respective engagement trend curves and respective types, flagging the bug as a lifecycle anomaly responsive to determining the bug has not been resolved and has been active longer than other bugs in a same cluster as the bug, or a combination thereof.

The operation 996 can include the evolutionary relevance mapping (ERM). The ERM can include functional obsolescence detection to determine that a feature, code path, or software module essential to the bug has not been removed from the current instance of the software application. The ERM can include dependency evolution analysis that determines that there are no changes in a third-party library or application programming interface (API) that have addressed a root cause of the bug. The ERM can include reproducibility validation that verifies the bug still exists in the current instance of the software application. The ERM can include root cause continuity mapping that determines the root cause of the bug is still valid in the current instance of the software application.

The method 900 can further include prioritizing the bug along with other stale bugs including indicating that the bug is a high priority bug, and mitigating the bug occurs responsive to prioritizing the to a high priority bug.

The operation 996 can include the cross-version similarity modeling (CVSM). The CVSM can include clustering bugs, including the bug, based on feature embeddings of a title and a description of the bugs and a metadata vector of the bugs indicating a platform and operating system associated with the bugs, responsive to determining the bug is part of a cluster that includes a bug associated with the current instance of the software application and a bug associated with a prior version of the software application, flagging the bug as recurring in the bug database, or a combination thereof.

The method 600 can further include responsive to determining a different bug is obsolete, not reproducible, no longer includes a root cause that is valid in the current instance of the software application, or a third-party library or application programming interface has addressed the bug removing the bug from the bug database.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

FIG. 10 illustrates, by way of example, a block diagram of an embodiment of a machine in the example form of a computer system 1000 within which instructions, for causing the machine to perform any one or more of the methodologies discussed herein, may be executed. The system 800, method 100, 200, 900, or a component thereof can be implemented using, or can include the system 1000 or a component thereof. The method 100, 200, 900, system 800, or a component or operation thereof can be implemented or performed by the computer system 1000. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 1021 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 1004 and a static memory 1006, which communicate with each other via a bus 1008. The memory 1004, 1006 can store parameters (sometimes called weights) that define operations of the processing circuitry (e.g., the processor 1002), an NN component, or other component of the system 1000. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker), a network interface device 1020, and radios 1030 such as Bluetooth, WWAN, WLAN, and NFC, permitting the application of security controls on such protocols. Note that a space vehicle does not typically include a display, UI navigation device, or the like.

The machine 1000 as illustrated includes an output controller 1028. The output controller 1028 manages data flow to/from the machine 1000. The output controller 1028 is sometimes called a device controller, with software that directly interacts with the output controller 1028 being called a device driver.

### Machine-Readable Medium

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004, the static memory 1006, and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Notes and Examples

Example 1 includes a method for bug mitigation in a software application, the method comprising accessing, by a bug database, bug data of a bug of the software application that is not resolved, performing, by processing circuitry, temporal decay analysis on the bug, the temporal decay analysis assesses developer activity on and lifecycle of the bug over time to identify that the bug has become stale, responsive to identifying the bug has become stale, flagging, by the processing circuitry, the bug as stale in the bug database, responsive to identifying the bug has become stale, performing, by the processing circuitry, at least one of: (i) evolutionary relevance mapping on the bug to determine the bug is still relevant in a current instance of the software application or (ii) cross-version similarity modeling to identify the bug has recurred in the current instance of the software application, and mitigating the bug responsive to determining the bug is still relevant or has recurred in the current instance of the software application resulting in an updated software application.

In Example 2, Example 1 further includes, wherein the temporal decay analysis includes engagement trend analysis including generating, by aggregating engagement data with the bug, an engagement trend curve indicating developer engagement with the bug over time, determining, by comparing data of the engagement trend curve to first specified criterion, the developer engagement meets the first specified criterion, and responsive to determine the developer engagement meets the first specified criterion, flagging the bug as stale.

In Example 3, at least one of Examples 1-2 further includes, wherein the temporal decay analysis includes engagement entropy analysis including generating an engagement trend curve indicating developer engagement with the bug over time, determining, based on the engagement trend curve, an engagement entropy, determining the engagement entropy meets second specified criterion, and responsive to determine the engagement entropy meets the second specified criterion, flagging the bug as stale.

In Example 4, at least one of Examples 1-3 further includes, wherein the temporal decay analysis includes lifecycle pattern analysis including generating an engagement trend curve indicating developer engagement with the bug over time, clustering the bug with other bus based on their respective engagement trend curves and respective types, and flagging the bug as a lifecycle anomaly responsive to determining the bug has not been resolved and has been active longer than other bugs in a same cluster as the bug.

In Example 5, at least one of Examples 1~4 further includes, wherein the evolutionary relevance mapping includes functional obsolescence detection to determine that a feature, code path, or software module essential to the bug has not been removed from the current instance of the software application.

In Example 6, at least one of Examples 1-5 further includes, wherein the evolutionary relevance mapping includes dependency evolution analysis that determines that there are no changes in a third-party library or application programming interface (API) that have addressed a root cause of the bug.

In Example 7, at least one of Examples 1-6 further includes, wherein the evolutionary relevance mapping includes reproducibility validation that verifies the bug still exists in the current instance of the software application.

In Example 8, at least one of Examples 1-7 further includes, wherein the evolutionary relevance mapping includes root cause continuity mapping that determines the root cause of the bug is still valid in the current instance of the software application.

In Example 9, at least one of Examples 1-8 further includes prioritizing the bug along with other stale bugs including indicating that the bug is a high priority bug, and mitigating the bug occurs responsive to prioritizing the to a high priority bug.

In Example 10, at least one of Examples 1-9 further includes, wherein the cross-version similarity modeling includes clustering bugs, including the bug, based on feature embeddings of a title and a description of the bugs and a metadata vector of the bugs indicating a platform and operating system associated with the bugs, and responsive to determining the bug is part of a cluster that includes a bug associated with the current instance of the software application and a bug associated with a prior version of the software application, flagging the bug as recurring in the bug database.

In Example 11, at least one of Examples 1-9 further includes responsive to determining a different bug is obsolete, not reproducible, no longer includes a root cause that is valid in the current instance of the software application, or a third-party library or application programming interface has addressed the bug removing the bug from the bug database.

Example 12 includes a non-transitory machine-readable medium including instructions that, when executed by a machine, cause the machine to perform operations for bug mitigation, the operations comprising performing temporal decay analysis on a bug associated with a software application, the temporal decay analysis assesses developer activity on and lifecycle of the bug over time to identify that the bug has become stale, responsive to identifying the bug has become stale, performing cross-version similarity modeling to identify the bug has recurred in a current instance of the software application, and mitigating the bug responsive to determining the bug recurred in the current instance of the software application resulting in an updated software application.

In Example 13, Example 12 further includes, wherein the temporal decay analysis includes engagement trend analysis including generating an engagement trend curve indicating developer engagement with the bug over time, determining the developer engagement meets first specified criterion, and responsive to determine the developer engagement meets the first specified criterion, flagging the bug as stale.

In Example 14, at least one of Examples 12-13 further includes, wherein the temporal decay analysis includes engagement entropy analysis including generating an engagement trend curve indicating developer engagement with the bug over time, determining, based on the engagement trend curve, an engagement entropy, determining the engagement entropy meets second specified criterion, and responsive to determine the engagement entropy meets the second specified criterion, flagging the bug as stale.

In Example 15, at least one of Examples 12-14 further includes, wherein the temporal decay analysis includes lifecycle pattern analysis including generating an engagement trend curve indicating developer engagement with the bug over time, clustering the bug with other bus based on their respective engagement trend curves and respective types, and flagging the bug as a lifecycle anomaly responsive to determining the bug has not been resolved and has been active longer than other bugs in a same cluster as the bug.

In Example 16, at least one of Examples 12-15 further includes, wherein the cross-version similarity modeling includes clustering bugs, including the bug, based on feature embeddings of a title and a description, and a metadata vector of the bugs vector of the bugs indicating a platform and operating system associated with the bugs, and responsive to determining the bug is part of a cluster that includes a bug associated with the current instance of the software application and a bug associated with a prior version of the software application, flagging the bug as recurring in a bug database.

Example 17 includes a system comprising a vector database storing bug identifications and corresponding features, the features including a title embedding, a description embedding, and a metadata vector for each of the bugs, a bug database storing the bug identifications and corresponding bug reports and cluster data for each of the bugs, the cluster data indicating a cluster of which the bug is a member, and processing circuitry configured to perform temporal decay analysis on a bug of the bugs associated with an instance of a software application, the temporal decay analysis assesses developer activity on and lifecycle of the bug over time to identify that the bug has become stale, responsive to identifying the bug has become stale, flag the bug as stale in a bug database, responsive to identifying the bug has become stale, perform evolutionary relevance mapping on the bug to determine the bug is still relevant in a current instance of the software application, and litigate the bug responsive to determining the bug is still relevant in the current instance of the software application resulting in an updated software application.

In Example 18, Example 17 further includes, wherein the evolutionary relevance mapping includes functional obsolescence detection to determine that a feature, code path, or software module essential to the bug has not been removed from the current instance of the software application.

In Example 19, at least one of Examples 17-18 further includes, wherein the evolutionary relevance mapping includes dependency evolution analysis that determines that there are no changes in a third-party library or application programming interface (API) that have addressed a root cause of the bug.

In Example 20, at least one of Examples 17-20 further includes, wherein the evolutionary relevance mapping includes reproducibility validation that verifies the bug still exists in the current instance of the software application.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for bug mitigation in a software application, the method comprising:
accessing, by a bug database, bug data of a bug of the software application that is not resolved;
performing, by processing circuitry, temporal decay analysis on the bug, the temporal decay analysis assesses developer activity on and lifecycle of the bug over time to identify that the bug has become stale;
responsive to identifying the bug has become stale, flagging, by the processing circuitry, the bug as stale in the bug database;
responsive to identifying the bug has become stale, performing, by the processing circuitry, at least one of: (i) evolutionary relevance mapping on the bug to determine the bug is still relevant in a current instance of the software application or (ii) cross-version similarity modeling to identify the bug has recurred in the current instance of the software application; and
mitigating the bug responsive to determining the bug is still relevant or has recurred in the current instance of the software application resulting in an updated software application.

2. The method of claim 1, wherein the temporal decay analysis includes engagement trend analysis including:
generating, by aggregating engagement data with the bug, an engagement trend curve indicating developer engagement with the bug over time;
determining, by comparing data of the engagement trend curve to first specified criterion, the developer engagement meets the first specified criterion; and
responsive to determine the developer engagement meets the first specified criterion, flagging the bug as stale.

3. The method of claim 1, wherein the temporal decay analysis includes engagement entropy analysis including:
generating an engagement trend curve indicating developer engagement with the bug over time;
determining, based on the engagement trend curve, an engagement entropy;
determining the engagement entropy meets second specified criterion; and
responsive to determine the engagement entropy meets the second specified criterion, flagging the bug as stale.

4. The method of claim 1, wherein the temporal decay analysis includes lifecycle pattern analysis including:
generating an engagement trend curve indicating developer engagement with the bug over time;
clustering the bug with other bus based on their respective engagement trend curves and respective types; and
flagging the bug as a lifecycle anomaly responsive to determining the bug has not been resolved and has been active longer than other bugs in a same cluster as the bug.

5. The method of claim 1, wherein the evolutionary relevance mapping includes functional obsolescence detection to determine that a feature, code path, or software module essential to the bug has not been removed from the current instance of the software application.

6. The method of claim 1, wherein the evolutionary relevance mapping includes dependency evolution analysis that determines that there are no changes in a third-party library or application programming interface (API) that have addressed a root cause of the bug.

7. The method of claim 1, wherein the evolutionary relevance mapping includes reproducibility validation that verifies the bug still exists in the current instance of the software application.

8. The method of claim 1, wherein the evolutionary relevance mapping includes root cause continuity mapping that determines the root cause of the bug is still valid in the current instance of the software application.

9. The method of claim 1, further comprising:
prioritizing the bug along with other stale bugs including indicating that the bug is a high priority bug; and
mitigating the bug occurs responsive to prioritizing the to a high priority bug.

10. The method of claim 1, wherein the cross-version similarity modeling includes:
clustering bugs, including the bug, based on feature embeddings of a title and a description of the bugs and a metadata vector of the bugs indicating a platform and operating system associated with the bugs; and
responsive to determining the bug is part of a cluster that includes a bug associated with the current instance of the software application and a bug associated with a prior version of the software application, flagging the bug as recurring in the bug database.

11. The method of claim 1, further comprising responsive to determining a different bug is obsolete, not reproducible, no longer includes a root cause that is valid in the current instance of the software application, or a third-party library or application programming interface has addressed the bug removing the bug from the bug database.

12. A non-transitory machine-readable medium including instructions that, when executed by a machine, cause the machine to perform operations for bug mitigation, the operations comprising:
performing temporal decay analysis on a bug associated with a software application, the temporal decay analysis assesses developer activity on and lifecycle of the bug over time to identify that the bug has become stale;
responsive to identifying the bug has become stale, performing cross-version similarity modeling to identify the bug has recurred in a current instance of the software application; and
mitigating the bug responsive to determining the bug recurred in the current instance of the software application resulting in an updated software application.

13. The non-transitory machine-readable medium of claim 12, wherein the temporal decay analysis includes engagement trend analysis including:
generating an engagement trend curve indicating developer engagement with the bug over time;
determining the developer engagement meets first specified criterion; and
responsive to determine the developer engagement meets the first specified criterion, flagging the bug as stale.

14. The non-transitory machine-readable medium of claim 12, wherein the temporal decay analysis includes engagement entropy analysis including:
generating an engagement trend curve indicating developer engagement with the bug over time;
determining, based on the engagement trend curve, an engagement entropy;
determining the engagement entropy meets second specified criterion; and
responsive to determine the engagement entropy meets the second specified criterion, flagging the bug as stale.

15. The non-transitory machine-readable medium of claim 12, wherein the temporal decay analysis includes lifecycle pattern analysis including:
generating an engagement trend curve indicating developer engagement with the bug over time;
clustering the bug with other bus based on their respective engagement trend curves and respective types; and
flagging the bug as a lifecycle anomaly responsive to determining the bug has not been resolved and has been active longer than other bugs in a same cluster as the bug.

16. The non-transitory machine-readable medium of claim 12, wherein the cross-version similarity modeling includes:
clustering bugs, including the bug, based on feature embeddings of a title and a description, and a metadata vector of the bugs vector of the bugs indicating a platform and operating system associated with the bugs; and
responsive to determining the bug is part of a cluster that includes a bug associated with the current instance of the software application and a bug associated with a prior version of the software application, flagging the bug as recurring in a bug database.

17. A system comprising:
a vector database storing bug identifications and corresponding features, the features including a title embedding, a description embedding, and a metadata vector for each of the bugs;
a bug database storing the bug identifications and corresponding bug reports and cluster data for each of the bugs, the cluster data indicating a cluster of which the bug is a member; and
processing circuitry configured to:
perform temporal decay analysis on a bug of the bugs associated with an instance of a software application, the temporal decay analysis assesses developer activity on and lifecycle of the bug over time to identify that the bug has become stale;
responsive to identifying the bug has become stale, flag the bug as stale in a bug database;
responsive to identifying the bug has become stale, perform evolutionary relevance mapping on the bug to determine the bug is still relevant in a current instance of the software application; and
mitigate the bug responsive to determining the bug is still relevant in the current instance of the software application resulting in an updated software application.

18. The system of claim 17, wherein the evolutionary relevance mapping includes functional obsolescence detection to determine that a feature, code path, or software module essential to the bug has not been removed from the current instance of the software application.

19. The system of claim 17, wherein the evolutionary relevance mapping includes dependency evolution analysis that determines that there are no changes in a third-party library or application programming interface (API) that have addressed a root cause of the bug.

20. The system of claim 17, wherein the evolutionary relevance mapping includes reproducibility validation that verifies the bug still exists in the current instance of the software application.
